(19) United States
(12) Patent Application Publication
(10) Pub. No.: US 2007/0125710 A1
(43) Pub. Date: Jun. 7, 2007

(54) Non-electric zero waste reverse osmosis water filtering system

(76) Inventor: Craig Schmitt, Phoenix, AZ (US)

Correspondence Address: FISH & RICHARDSON PC, P.O. BOX 1022, MINNEAPOLIS, MN, 55440-1022, US

(21) Appl. No.: 11/292,551

(22) Filed: Dec. 2, 2005

(51) Int. Cl. C02F 1/44

(52) U.S. Cl. 210/652

(57) ABSTRACT

A reverse osmosis filter system including a non-electric valve-pump assembly that allows the filter system to create zero waste and operate without electricity. The assembly includes two valves that are mechanically coupled to pistons of a pump, and in fluid communication with containers of the pump. Opening one of the valves allows the pistons to be moved in a first direction using the pressure of a cold water feed line. The pistons move in the first direction until the mechanically coupled first valve is closed and the second valve is opened, wherein the second opened valve allows the pistons to be moved in a second direction using the pressure of the cold water feed line. These movements are repeated to create a pumping action and the pump containers are sized so that concentrate water is delivered under pressure to a hot water feed line.

### TECHNICAL FIELD OF THE DISCLOSURE

The present disclosure relates to a reverse osmosis water filtering system and, more particularly, to a zero waste reverse osmosis water filtering system.

### BACKGROUND OF THE DISCLOSURE

FIG. 1 shows a typical reverse osmosis (RO) water filtering system 10 constructed in accordance with the prior art. The system 10 includes a filter assembly 14, a reverse osmosis membrane 18, a reverse osmosis storage tank 22, a flow restrictor 26, a shut-off valve 28, a carbon filter 70 and an auxiliary faucet 72. The filter assembly 14 includes a sediment filter 30 and carbon filters 34a, 34b. Intake water enters the system 10 from a cold-water angle stop valve 36, which is connected to a cold-water source 84, and is routed through an intake tube 38 to filter assembly 14. The cold-water angle stop valve 36 is also connected to a standard faucet 62 through a cold-water faucet line 64 providing cold water to the standard faucet.

The sediment filter 30 removes sediment such as sand and dirt and the like from the intake water, while the carbon filters 34a and 34b remove chlorine and other contaminants that cause bad color, odor and taste. The filtered water is then routed to the membrane 18 through a water tube 40.

The membrane 18 includes three ports: an intake port 42, a permeate outlet port 46, and a concentrate outlet port 50. The intake port 42 receives filtered intake water from the filter assembly 14 through the water tube 40. The permeate water is routed from outlet port 46 through permeate tubes 52a and 52b and shut-off valve 28 to tank 22 to be stored under pressure. The shut-off valve 28 is automatic and stops the flow of water to the membrane 18 and to the tank 22 when the tank is full. When the auxiliary faucet 72 is opened by a user, permeate water is forced from the tank 22, through a carbon filter 70, and though the faucet 72. Concentrate water is routed from the outlet port 50 through a wastewater tube 78 through a drain tube 74 for subsequent disposal down drain 68. Including a flow restrictor 26 in the wastewater tube 78 can reduce the flow of concentrate water to the drain 68.

Since water shortages are a problem in many arid and highly populated regions of the world, such as southern California, it is preferably that the concentrate water not be routed to the drain 68 in order to conserve water. Reverse osmosis systems that do not route the concentrate to the drain are referred to as “zero waste” reverse osmosis systems.

For a common household reverse osmosis system, it has been suggested that the concentrate water can be discharged into the hot water line of the home for reuse instead of being routed to the drain. Because domestic hot water is not normally used for drinking, the presence of the concentrate water in the hot water line is acceptable. Suitable systems for discharging the concentrate water into the hot water line, however, require that the pressure of the concentrate water be raised above the pressure of the hot water line into which it will be injected.

FIG. 2 shows a zero waste RO water filtering system 110 constructed in accordance with the prior art. The system 110 of FIG. 2 is similar to the system 10 of FIG. 1 such that similar elements have the same reference numerals. In the system 110 of FIG. 2, however, the concentrate water is routed to a valve on the hot water angle stop 66 through tube 80 that has a flow restrictor 86 and two check valves 88a, 88b. The flow restrictor 86 is a larger rated flow restrictor than flow restrictor 26 of FIG. 1 in order to offset the backpressure from hot water source. The check valves 88a and 88b prevent hot water from the hot water source 82 from entering membrane 18 due to any backpressure that may occur.

The system 110 also includes an electric valve-pump assembly 90 between the membrane 18 and the filtering system 14. The electric valve-pump assembly 90 includes a solenoid valve 91, an electric pump 92, a pump intake tube 93, a valve-pump tube 94 that allows water to flow between the pump and the solenoid valve, a valve outlet tube 95, a pressure switch 96 that is electrically connected to the pump and the solenoid valve by a wire harness 97, and a transformer 98 that supplies power to the pump, the switch, and the valve.

The transformer 98 is connected to an electric wall outlet (not shown), the pump intake tube 93 connects the filtering system 14 to the pump 92 and the valve outlet tube 95 connects the solenoid valve 91 to inlet port of the membrane 18. The pressure switch 96 is connected between the permeate tubes 52a and 52b.

In operation, the user opens reverse osmosis faucet 72 and the permeate water in the tank 10 is forced from the tank by the pressure within the tank. As the tank 22 is being depleted of permeate water, the pressure switch 96 detects that the pressure within the tank is below a predetermined pressure that corresponds to the tank being filled. The pressure switch 96 then electrically opens the solenoid valve 91 and electrically engages the pump 92 to pump filtered water received from the filtering system 14 through the open solenoid valve through the outlet valve tube 95 to the membrane 18. The pump 92 continues pumping filtered water to the membrane 18 until the switch 96 detects that the pressure within tank 22 has reached a predetermined pressure, which corresponds to tank 22 being full. The pump 92 also acts to provide enough system pressure to inject the concentrate water from the membrane 18 into the hot water line at 66. At the predetermined pressure, the switch 96 electrically disengages the pump 92 from pumping filtered water from the filter system 14 to the membrane 18 and closes solenoid valve 91.

What is still desired is a new and improved reverse osmosis water filtering system. Among other advantages and benefits, the new and improved reverse osmosis water filtering system will preferably create zero waste. Moreover, the new and improved reverse osmosis water filtering system will preferably operate without requiring electricity.

### SUMMARY OF THE DISCLOSURE

The present disclosure provides a new and improved reverse osmosis water filtering system including a non-electric valve-pump assembly that allows the reverse osmosis water filtering system to create zero waste and operate without electricity. The valve-pump assembly receives cold water from a cold water feed line, delivers the cold water to an inlet of a reverse osmosis membrane filter, receives concentrate water from a concentrate water outlet of the reverse osmosis membrane filter, and delivers the concentrate water under pressure to a hot water feed line.

According to one exemplary embodiment, the valve-pump assembly includes first and second valves having bodies defining first ports for connection to the cold water line, and second ports for connection to the inlet of the reverse osmosis membrane filter. The valves also include members contained in the bodies and moveable between first and second positions. In the first position, the member of the first valve closes the first port and opens the second port, while in the second position; the member of the first valve opens the first port and closes the second port. In the first position, the member of the second valve opens the first port and closes the second port, while in the second position; the member of the second valve closes the first port and opens the second port.

The valve-pump assembly also includes a pump having three connected containers, and three pistons received, respectively, in the containers. The three pistons are mechanically coupled for synchronized movement. A first of four chambers successively defined by the pistons and the containers includes a port connected to a third port of the first valve body. A fourth of the four chambers includes a port connected to a third port of the second valve body. A second of the four chambers includes a first port for connection to the concentrate water outlet of the reverse osmosis membrane filter and a second port for connection to the hot water line. A third of the four chambers includes a first port for connection to the concentrate water outlet of the reverse osmosis membrane filter and a second port for connection to the hot water line.

The pump also includes a lever coupled to the pistons and movable between a first position wherein the pistons are positioned so that the first chamber of the pump is maximized and the fourth chamber is minimized, and a second position wherein the pistons are positioned so that the first chamber is minimized and the fourth chamber is maximized. The assembly further includes a linkage mechanically coupling the lever of the pump to the valve members of the first and the second valves, so that movement of the lever to the first position causes the valve members to be moved to their first positions and movement of the lever to the second position causes the valve members to be moved to their second positions.

Additional aspects and advantages of the present disclosure will become readily apparent to those skilled in this art from the following detailed description, wherein only an exemplary embodiment of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

Reference is made to the attached drawings, wherein elements having the same reference character designations represent like elements throughout, and wherein:

FIG. 1 is a diagrammatic plan view of an exemplary embodiment of a reverse osmosis water filtering system constructed in accordance with the prior art, wherein concentrate water produced by the system is directed to a sink drain as waste;

FIG. 2 is a diagrammatic plan view of an exemplary embodiment of a “zero waste” reverse osmosis water filtering system constructed in accordance with the prior art and including an electric valve-pump assembly that injects concentrate water produced by the system into a hot water source for reuse as part of the hot water source;

FIG. 3 is a diagrammatic plan view of an exemplary embodiment of a “zero waste” reverse osmosis water filtering system constructed in accordance with the present disclosure and including a non-electric valve-pump assembly that injects concentrate water produced by the system into a hot water source for reuse as part of the hot water source;

FIG. 4 is an enlarged diagrammatic plan view of the non-electric valve-pump assembly of FIG. 3, wherein the non-electric valve-pump assembly is shown in a first position; and

FIG. 5 is an enlarged diagrammatic plan view of the non-electric valve-pump assembly of FIG. 3, wherein the non-electric valve-pump assembly is shown in a second position.

### DETAILED DESCRIPTION OF EXEMPLARY EMBODIMENTS

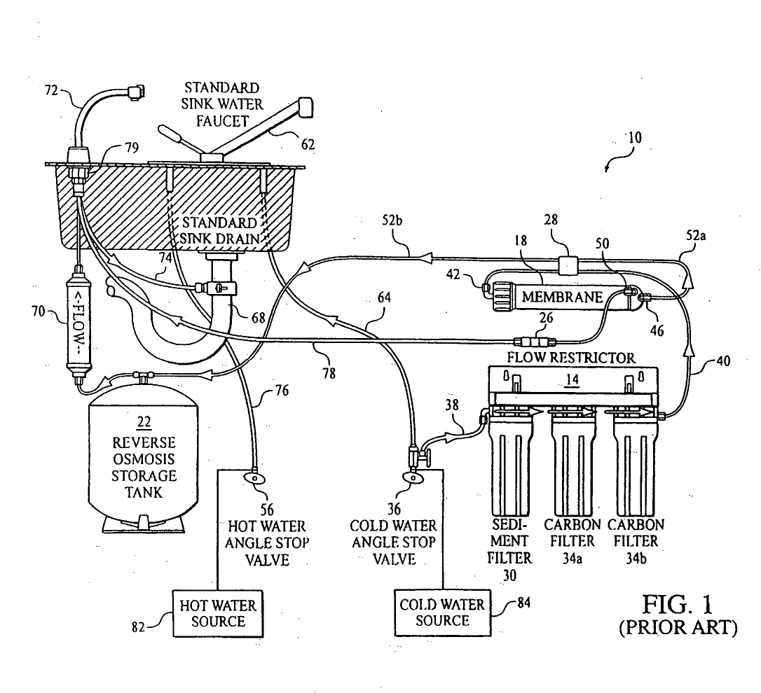

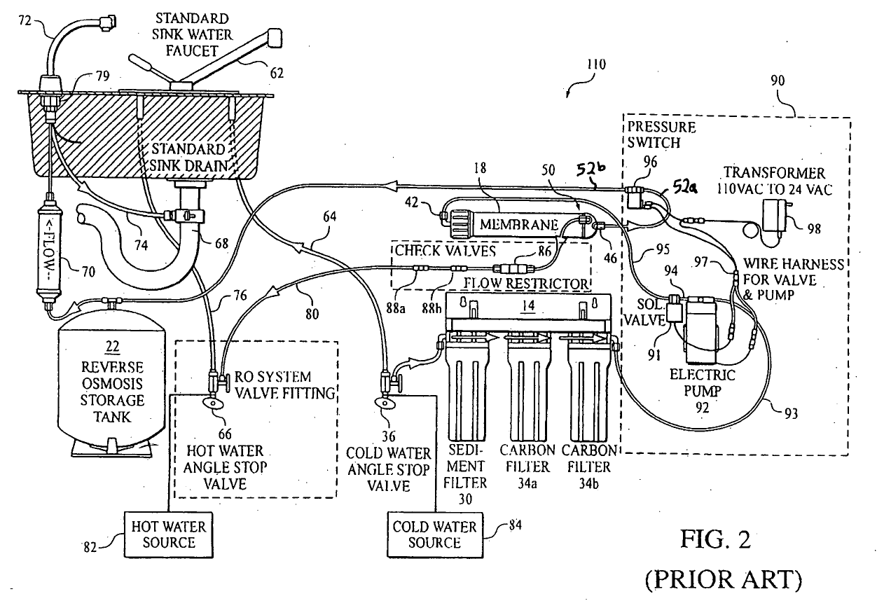

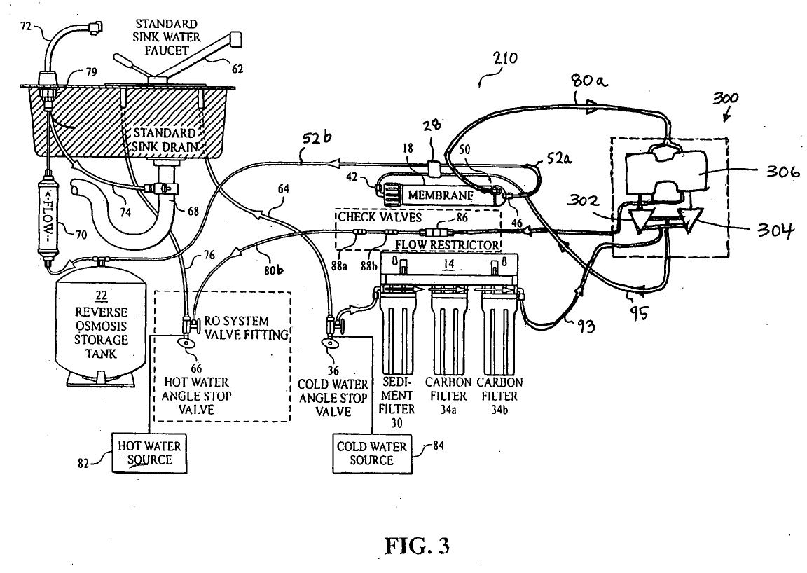

Referring to FIG. 3, the present disclosure provides a non-electric valve-pump assembly 300 for use as part of a new and improved zero waste reverse osmosis (RO) tap water filtering system 210. The RO filtering system 210 of FIG. 3 is generally similar to the system 10 of FIG. 1 and the system 110 of FIG. 2, such that similar elements have the same reference numerals. The zero waste RO filtering system 210 of FIG. 3, however, includes an exemplary embodiment of the non-electric valve-pump assembly 300 constructed in accordance with the present disclosure. Among other advantages and benefits, the non-electric valve-pump assembly 300 provided by the present disclosure allows the new and improved RO filtering system 210 to create zero waste without requiring electricity. In particular, the valve-pump assembly 300 provides a pressure boost that allows concentrate water to be injected into the hot water source 66 for reuse instead of being disposed of directly to the drain 68. The valve-pump assembly 300 is self-regulating and operates without electricity using the pressure of the cold water source 84.

Referring to FIG. 3, the non-electric valve-pump assembly 300 receives filtered cold water from the cold water source 84 via the filter assembly 14 and tube 93, delivers the filtered cold water to the inlet 42 of the reverse osmosis membrane filter 18 via tube 95, receives concentrate water from the concentrate water outlet 50 of the reverse osmosis membrane filter 18 via tube 80a, and delivers the concentrate water to the hot water source 66 via tube 80b.

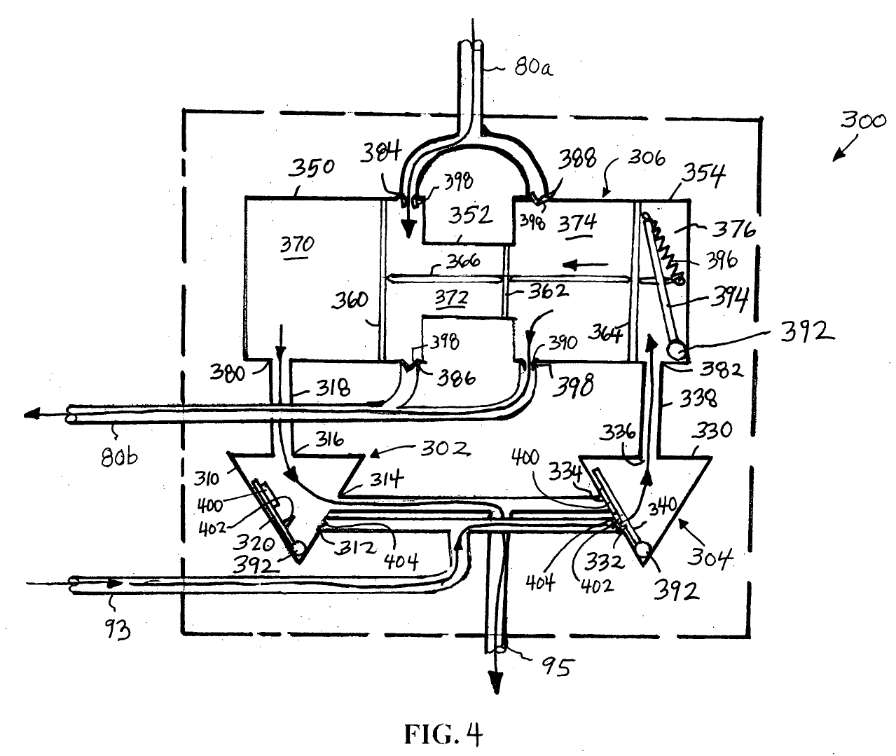

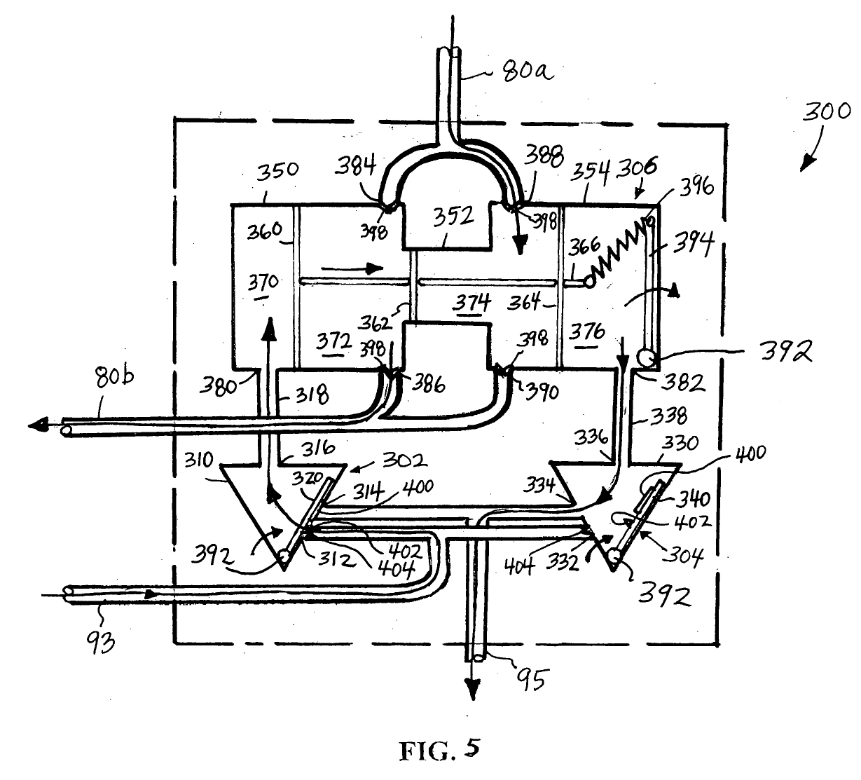

As its name implies, the valve-pump assembly 300 includes valves 302, 304 and a pump 306, as shown in FIGS. 3-5. In FIG. 4 the non-electric valve-pump assembly 300 is shown in a first operational position, while in FIG. 5, the non-electric valve-pump assembly 300 is shown in a second operational position.

Referring to FIGS. 4 and 5, a first of the valves 302 includes a valve body 310 defining a first port 312 connected to the cold water source 84 via the filter assembly 14 and tube 93, a second port 314 connected to the inlet 42 of the reverse osmosis membrane filter 18 via tube 95, and a third port 316 connected to the pump via tube 318. The first valve 302 also includes a valve member 320 contained in the valve body 310 and moveable between a first position wherein the member 320 closes the first port 312 and opens the second port 314 and a second position wherein the member 320 opens the first port 312 and closes the second port 314. In FIG. 4, the valve member 320 is shown in the first position, and in FIG. 5 the valve member 320 is shown in the second position.

The second valve 304 includes a valve body 330 defining a first port 332 connected to the filtered cold water tube 93, a second port 334 connected to the inlet 42 of the reverse osmosis membrane filter 18 via tube 95, and a third port 336 which is connected to the pump 306 via tube 338. The second valve 304 also includes a valve member 340 contained in the valve body 330 and moveable between a first position wherein the member 340 opens the first port 332 and closes the second port 334 and a second position wherein the member 340 closes the first port 332 and opens the second port 334. In FIG. 4, the valve member 340 of the second valve 304 is shown in the first position, and in FIG. 5 the valve member 340 is shown in the second position.

Referring to FIGS. 4 and 5, the pump 306 includes first, second, and third containers 350, 352, 354 connected together, a first piston 360 slidingly received in the first container 350, a second piston 362 slidingly received in the second container 352, and a third piston 364 slidingly received in the third container 354. A member 366 mechanically couples the pistons 360, 362, 364 for synchronized movement.

The pistons 360, 362, 364 and the containers 350, 352, 354 form four chambers 370, 372, 374, 376 (as viewed from left to right in FIGS. 4 and 5). The first chamber 370 includes a port 380 connected to the third port 316 of the first valve body 310 via tube 318, and the fourth chamber 376 includes a port 382 connected to the third port 336 of the second valve body 330 via tube 338. The second chamber 372 includes a first port 384 connected to the concentrate water outlet 50 of the reverse osmosis membrane filter 18 via tube 80a and a second port 386 connected to the hot water source 66 via tube 80b. The third chamber 374 includes a first port 388 connected to the concentrate water outlet 50 of the reverse osmosis membrane filter 18 via tube 80a and a second port 390 connected to the hot water source 66 via tube 80b.

The pump 306 further includes a lever 394 coupled to the pistons 360, 362, 364 and movable between a first position wherein the pistons are positioned so that a volume of the first chamber 370 of the pump is maximized and a volume of the fourth chamber 376 is minimized, and a second position wherein the pistons are positioned so that a volume of the first chamber 370 is minimized and a volume of the fourth chamber 376 is maximized. In FIG. 4, the pump 306 is shown in the first position, and in FIG. 5 the pump 306 is shown in the second position.

Still referring to FIGS. 4 and 5, the valve-pump assembly 300 further includes a linkage 392 mechanically coupling the lever 394 of the pump 306 to the valves members 320, 340 of the first and the second valves 302, 304. Because of the linkage 392, movement of the lever 394 to the first position causes the valve members 320, 340 to be moved to their first positions, as shown in FIG. 4, and movement of the lever 394 to the second position causes the valve members 320, 340 to be moved to their second positions, as shown in FIG. 5.

As shown in FIGS. 4 and 5 the second container 352 of the pump has a smaller cross-section than the first and the third containers 350, 354. The smaller cross-section of the second container 352 allows the volumes of the second and third chambers 372, 374 to change more rapidly than the volumes of the first and the fourth chambers 370, 376 upon movement of the pistons 360, 362, 364. According to one exemplary embodiment, the ratio of change is at least 4 to 1. Thus filtered cold water entering the first chamber 370 will cause concentrate water to exit the second chamber 372 at a higher pressure than the filtered cold water since the volume of the second chamber 372 decreases more rapidly than the increase in the volume of the first chamber 370. In addition, filtered cold water entering the fourth chamber 376 will cause concentrate water to exit the third chamber 374 at a higher pressure than the filtered cold water since the volume of the third chamber 374 decreases more rapidly than the increase in the volume of the fourth chamber 376.

According to one exemplary embodiment, the linkage 392 rotates about its axis and ends of the lever 394 and the valve members 320, 340 are secured to the linkage 392 such that the lever and the valve members pivot about the linkage. In addition, an end of the lever 394 of the pump is secured to the member 366 of the pistons by a tension spring 396.

Check valves 398 are operatively positioned within the ports 384, 386 of the second chamber 372 and the ports 388, 390 in the third chamber 374 of the pump to prevent backflow. In the exemplary embodiment shown, the valve members 320, 340 have seals 400 for closing the second ports 314, 334 of the valves and prongs 402 for opening check valves 404 operatively positioned within the first ports 312, 322 of the valves.

The present disclosure, therefore, provides a new and improved non-electric zero waste reverse osmosis water filtering system. It should be understood, however, that the exemplary embodiment described in this specification has been presented by way of illustration rather than limitation, and various modifications, combinations and substitutions may be effected by those skilled in the art without departure either in spirit or scope from this disclosure in its broader aspects and as set forth in the appended claims. Accordingly, other embodiments are within the scope of the following claims. In addition, the system disclosed herein, and all elements thereof, are contained within the scope of at least one of the following claims. No elements of the presently disclosed non-electric zero waste reverse osmosis water filtering system are meant to be disclaimed.

What is claimed is:

1. A valve-pump assembly for receiving cold water from a cold water line, delivering the cold water to an inlet of a reverse osmosis membrane filter, receiving concentrate water from a concentrate water outlet of the reverse osmosis membrane filter, and delivering the concentrate water to a hot water line, the valve-pump assembly comprising:
a first valve including,
a valve body defining a first port for connection to the cold water line, a second port for connection to the inlet of the reverse osmosis membrane filter, and a third port, and
a valve member contained in the valve body and moveable between a first position wherein the member closes the first port and opens the second port and a second position wherein the member opens the first port and closes the second port;
a second valve including,
a valve body defining a first port for connection to the cold water line, a second port for connection to the inlet of the reverse osmosis membrane filter, and a third port, and
a valve member contained in the valve body of the second valve and moveable between a first position wherein the member opens the first port and closes the second port and a second position wherein the member closes the first port and opens the second port;
a pump including,
first, second, and third connected containers, wherein the second container of the pump has a smaller cross-section than the first and the second containers,
a first piston slidingly received in the first container, a second piston slidingly received in the second container, and a third piston slidingly received in the third container, the pistons mechanically coupled for synchronized movement, wherein the pistons and the containers form four chambers, and wherein,
a first of the four chambers includes a port connected to the third port of the first valve body,
a fourth of the four chambers includes a port connected to the third port of the second valve body,
a second of the four chambers includes a first port for connection to the concentrate water outlet of the reverse osmosis membrane filter and a second port for connection to the hot water line, and
a third of the four chambers includes a first port for connection to the concentrate water outlet of the reverse osmosis membrane filter and a second port for connection to the hot water line, and
a lever coupled to the pistons and movable between a first position wherein the pistons are positioned so that a volume of the first chamber of the pump is maximized and a volume of the fourth chamber is minimized, and a second position wherein the pistons are positioned so that the volume of the first chamber is minimized and the volume of the fourth chamber is maximized; and
a linkage mechanically coupling the lever of the pump to the valves members of the first and the second valves, so that movement of the lever to the first position causes the valve members to be moved to their first positions and movement of the lever to the second position causes the valve members to be moved to their second positions.

2. An assembly according to claim 1, wherein the linkage rotates about its axis and ends of the lever and the valve members are secured to the linkage such that the lever and the valve members pivot about the linkage.

3. An assembly according to claim 2, wherein an end of the lever of the pump is secured to the member of the pistons by a tension spring

4. An assembly according to claim 1, further comprising check valves operatively positioned within the ports of the second and the third chambers of the pump.

5. An assembly according to claim 1, wherein the valve members have seals for closing the second ports of the valves.

6. An assembly according to claim 1, wherein the valves have check valves operatively positioned within the first ports of the valve bodies and the valve members have prongs for opening the check valves of the first ports.

7. An assembly according to claim 1, wherein the second container of the pump has a smaller cross-section than the first and the third containers such that the volumes of the second and third chambers change more rapidly than volumes of the first and the fourth chambers upon movement of the pistons by a ratio of at least 4 to 1.

8. A reverse osmosis water filtering system including an assembly according to claim 1, and further comprising a reverse osmosis membrane filter having a concentrate water outlet connected to the first ports of the second and the third chambers of the pump of the assembly, and a water inlet connected to the second ports of the valves of the assembly.

9. A system according to claim 8, further comprising a sediment and carbon filter assembly having an outlet connected to the first ports of the valves of the valve-pump assembly and an inlet for connection to a cold water line.

10. A system according to claim 8, further comprising a tube having a first end connected to the second ports of the second and the third chambers of the pump of the assembly and having a second end for connection to a hot water line, wherein a flow restrictor is provided in the tube.

11. A system according to claim 8, further comprising a storage tank connected to a permeate water outlet of the reverse osmosis membrane filter, and a shut-off valve operatively connected between the storage tank and the reverse osmosis membrane filter and adapted to stop flow from the permeate water outlet upon the tank being full.

12. An under-sink reverse osmosis water filtering system comprising:
a reverse osmosis membrane filter having a water inlet, a concentrate water outlet, and a permeate water outlet adapted to be connected to a faucet;
a sediment and carbon filter assembly having an outlet and an inlet adapted to be connected to a cold water line;
a non-electric valve-pump assembly including,
a first valve including a valve body defining a first port connected to the outlet of the filter assembly, a second port connected to the inlet of the reverse osmosis membrane filter, and a third port, and a valve member moveable between a first position wherein the member closes the first port and opens the second port and a second position wherein the member opens the first port and closes the second port;
a second valve including a valve body defining a first port connected to the outlet of the filter assembly, a second port connected to the inlet of the reverse osmosis membrane filter, and a third port, and a valve member moveable between a first position wherein the member opens the first port and closes the second port and a second position wherein the member closes the first port and opens the second port;
a pump including,
first, second, and third connected containers,
first, second, and third pistons received in the containers,
four chambers formed by the pistons and the containers, wherein a first of the four chambers includes a port connected to the third port of the first valve body, a fourth of the four chambers includes a port connected to the third port of the second valve body, a second of the four chambers includes a first port connected to the concentrate water outlet of the reverse osmosis membrane filter and a second port for connection to a hot water line, and a third of the four chambers includes a first port connected to the concentrate water outlet of the reverse osmosis membrane filter and a second port for connection to the hot water line, and
a lever coupled to the pistons and movable between a first position wherein the pistons are positioned so that a volume of the first chamber of the pump is maximized and a volume of the fourth chamber is minimized, and a second position wherein the pistons are positioned so that the volume of the first chamber is minimized and the volume of the fourth chamber is maximized; and
a linkage mechanically coupling the lever of the pump to the valve members of the first and the second valves, so that movement of the lever to the first position causes the valve members to be moved to their first positions and movement of the lever to the second position causes the valve members to be moved to their second positions.

13. A system according to claim 12, wherein the containers of the pump are adapted such that the volumes of the second and third chambers change more rapidly than volumes of the first and the fourth chambers upon movement of the pistons.

14. A system according to claim 13, wherein the containers are adapted so that a ratio of change of the volumes of the chambers is at least 4 to 1.

15. A system according to claim 12, wherein the linkage of the valve-pump assembly rotates about its axis and ends of the lever and the valve members are secured to the linkage such that the lever and the valve members pivot together about the linkage.

16. A system according to claim 15, wherein an end of the lever of the pump is secured to the member of the pistons by a tension spring

17. A system according to claim 12, further comprising check valves operatively positioned within the ports of the second and the third chambers of the pump.

18. A system according to claim 12, wherein the valve members have seals for closing the second ports of the valves, check valves are operatively positioned within the first ports of the valve bodies, and the valve members also have prongs for opening the check valves of the first ports.

19. A system according to claim 12, further comprising a tube having a first end connected to the second ports of the second and the third chambers of the pump of the valve-pump assembly and having a second end for connection to a hot water line, wherein a flow restrictor is provided in the tube.

20. A system according to claim 12, further comprising a storage tank connected to the permeate water outlet of the reverse osmosis membrane filter, and a shut-off valve operatively connected between the storage tank and the reverse osmosis membrane filter and adapted to stop flow from the permeate water outlet upon the tank becoming full.
